(19) United States
(12) Patent Application Publication
(10) Pub. No.: US 2025/0028191 A1
(43) Pub. Date: Jan. 23, 2025

(54) FILMS FOR REDUCING THE PROGRESSION OF MYOPIA

(71) Applicant: Rodenstock GmbH, Muenchen (DE)

(72) Inventors: Gregor Esser, Muenchen (DE); Anne Seidemann, Muenchen (DE); Yohann Bénard, Muenchen (DE); Helmut Altheimer, Baisweil-Lauchdorf (DE); Dietmar Uttenweiler, Icking (DE)

(21) Appl. No.: 18/715,554

(22) PCT Filed: Dec. 7, 2022
(86) PCT No.: PCT/EP2022/084699

§ 371 Date: May 31, 2024

(30) Foreign Application Priority Data
Dec. 7, 2021 (DE) 10 2021 132 187.5

(51) Int. Cl. G02C 7/08

(52) U.S. Cl. CPC G02C 7/086

(57) ABSTRACT

An adhesion film includes an adhesion surface with which the adhesion film is arrangeable on a front or rear surface of the spectacle lens in order to adhesively stick there; and a functional surface opposite the adhesion surface with a central region and a peripheral region. The functional surface has a microstructure such that the microstructure in the peripheral region at least partially causes an additional positive dioptric power and/or a contrast reduction in relation to the central region.

### TECHNICAL FIELD

The invention relates to the objective of providing an existing spectacle lens with a peripheral refractive power variation or change which, in particular, can promote a delay in the increase in myopia of a spectacle wearer, by means of a suitable film.

### BACKGROUND

Myopia is increasing dramatically worldwide, particularly in Asia. The WHO estimates that over 50% of all people will be myopic by 2050. As an individual's myopia increases, the risk of associated eye diseases such as retinal detachment, glaucoma, cataracts and macular degeneration also increases very significantly. Therefore, there is great interest in slowing down the increase in myopia. In this respect, there are several approaches to slowing down the myopia progression with optical aids (visual aids). What all these approaches have in common, however, is that they are very complex and expensive and also quite inflexible to adapt to rapidly changing circumstances (e.g. changes in the prescription of spectacles, demands on the visual system).

To date, various optical powers relating to the tolerability and comfort of ophthalmic lenses, in particular spectacle lenses, have been investigated with regard to their influence on myopia and/or hyperopia as well as their progression or development depending on the optical and physiological mechanisms that are intended to explain or slow down progression or advancement, in particular deterioration. The existing approaches are essentially based on imaging the image in front of the retina, as this is intended to slow down the length growth of the eye. In this respect, it has been shown that it is sufficient (or even better) if this is only done in the periphery of the retina.

One possible approach is the use of bifocal spectacle lenses and/or progressive spectacle lenses (PAL). In this respect, on the one hand, a region is imaged in the peripheral region in front of the retina by the addition when looking into the distance and, on the other hand, the image is not imaged behind the retina when looking close up, at least if accommodation is insufficient. This works better in children with accommodation insufficiency and/or convergence excess. However, with such approaches, acceptable results are only achieved in a smaller group with convergence excess. Bifocal spectacle lenses are cosmetically unacceptable, in particular for children.

Another approach is based on special PALs (or radially symmetrical PALs) with a central sharply imaging power and peripheral addition (e.g. DE 10 2009 053 467 A1).

PALs, as in these two approaches, have regions with large aberrations. If the spectacle lens power changes, which is often the case with children, a new, expensive spectacle lens has to be produced with great effort. Furthermore, peripheral vision and also foveal vision, when looking through the periphery of the spectacle lenses, is greatly reduced by the aberrations. If high demands are placed on the visual system (e.g. in road traffic), this can only be solved with second single-vision spectacles. This further increases the effort and costs when changing the prescription. The acceptance of such solutions is therefore often low.

Other approaches are based on special contact lenses, for example. For example, progressive contact lenses with a higher plus power in the periphery than in the central region have been investigated. However, this also impairs foveal vision upon movement of the contact lens on the eye. In addition, in this case as well, a new lens has to be produced with great effort in case of a change in acuity. Furthermore, handling and reliability are limited in children. This is true in particular for young children, and the fact that the greatest effect is actually achieved if measures to slow down myopia are started especially at an early age makes things even more difficult.

Another approach with contact lenses uses so-called Ortho-K contact lenses which are worn overnight, deforming the cornea. This is intended to correct the myopia centrally and also create a plus power (compared to centrally) in the periphery. In this case as well, however, each contact lens is a special requirement and a new lens must also be manufactured with great effort, e.g. in the case of a new prescription. Furthermore, the impact of corneal deformation on the metabolism and structure of the cornea are unclear, in particular in young children.

The problem for spectacle wearers resulting from advancement of myopia is the steadily decreasing wearing comfort of spectacles once they have been fitted. The object of the present invention is thus to improve a lasting tolerability of spectacles and thus to achieve long-term wearing comfort at low cost.

### SUMMARY

According to the invention, this object is achieved by an adhesion film, the use of said film and by a method for applying adhesion films of this type to the spectacle lenses of spectacles with the features specified in the independent claims. Preferred embodiments are the subject matter of the dependent claims.

Thus, in one aspect, the invention relates to an adhesion film for a spectacle lens, comprising:
an (in particular substantially planar) adhesion surface with which the adhesion film can be arranged on a front or rear surface of the spectacle lens in order to adhesively stick there: and
a functional surface opposite the adhesion surface with a central region and a peripheral region, wherein the functional surface has a microstructure such that the microstructure in the peripheral region at least partially causes an additional positive dioptric power and/or a contrast reduction in relation to the central region.

The adhesion film is sufficiently flexible to adapt to curved surfaces of spectacle lenses. Preferably, the adhesion surface is covered with a peelable protective film before being applied to the spectacle lens to keep it as dust-free as possible. Indeed, adhesion films for spectacle lenses are already well known and commonly used as occlusion films, for example. However, the essential innovation is not least the additional positive dioptric power and its distribution on the functional surface of the adhesion film. Otherwise, experience with occlusion films can be drawn on for the adhesion film according to the invention, at least with regard to the materials used.

In a preferred embodiment, the microstructure is provided only in the peripheral region, but not in the central region. In any case, however, the microstructure does not produce the same power on the entire functional surface. In the central region in particular, no or only a slight additional positive dioptric power is produced and no or only a slight contrast reduction is caused. This ensures that a spectacle lens essentially still has the exact dioptric power (prescription power) intended for the user with the spectacle lens in the central region after applying the adhesion film, and the spectacle wearer can continue to have substantially unchanged central sharp vision with the spectacle lens. Only in the peripheral region, the additional positive dioptric power of the adhesion film, as compared to the actual spectacle lens, produces an optical image in front of the spectacle wearer's retina and/or at least prevents a sharp image of the peripheral vision from being focused behind the retina by contrast reduction, thus attenuating a stimulus for length expansion or length growth of the concerning eye. Thus, it turned out that the film according to the invention in particular prevents an image of the peripheral visual region from being focused behind the retina, which causes a stimulus for length growth of the eye. The attenuation of the stimulus for length growth thus also attenuates short-term myopic progression of the eye, which conventionally often leads to a loss of comfort when wearing the spectacle lens. An adhesion film according to the invention, in contrast, improves a lasting tolerability of spectacles and achieves long-term wearing comfort at low cost.

Thus, in one aspect, the invention provides for the use of an adhesion film of this type for a non-therapeutic purpose to improve the tolerability and wearing comfort when using ophthalmic lenses over a long period of time. In one aspect, the invention avoids undesirable deterioration of vision (myopia) of an eye as caused by conventional lenses. To this end, in one aspect, the invention relates in particular to the use of an adhesion film proposed herein for application to a spectacle lens with a negative dioptric power. Thus, especially in the case of an already existing myopia of an eye, which is compensated for by a spectacle lens with a negative dioptric power, the long-term maintenance of comfort when wearing this spectacle lens is achieved to a particularly significant extent. Against this background, in a further aspect, the invention thus relates in particular to a non-therapeutic use of an adhesion film proposed here for (non-therapeutic) reduction of the progression of myopia.

Preferably, the additional positive dioptric power in the peripheral region is a value in the range of about 1 dpt to about 5 dpt, preferably a value in the range of about 2 dpt to about 4 dpt. The peripheral defocusing thus achieved towards an image in front of the retina causes a particularly efficient attenuation of a stimulus for length growth of the eye. Both larger and smaller values of the peripheral additional positive dioptric power tend to continue to tolerate an existing tendency for length growth of the eye and thus to attenuate it less effectively. Thus, with lower values of the peripheral additional positive dioptric power, it occurs that the peripheral regions are still partially sharply imaged behind the retina with correct or possibly even slightly excessive accommodation in the central region and thus a stimulus for length growth of the eye is hardly or not at all suppressed. With larger values of the additional positive dioptric power, in contrast, the peripheral region is already perceived so blurred that the effective influence on length growth is greatly reduced, as the eye no longer perceives any significant difference between an image in front of or behind the retina.

In a preferred embodiment, the adhesion film has an inner effective region and an outer effective region in the peripheral region, which are at least partially separated from each other by an intermediate region, in particular an annular one, wherein the intermediate region has a lower additional positive dioptric power or a lower contrast reduction than the inner and outer effective regions. Here, the inner effective region forms a preferably annular region which is closer to the central region than the outer effective region, or which is directly adjacent to the central region. Here, the inner effective region is preferably surrounded by the intermediate region which, in turn, is further away from the central region than the inner effective region. Further towards the periphery, in turn, the intermediate region is surrounded by the outer effective region. While the inner and outer effective regions preferably have the additional positive dioptric power and/or (greater) contrast reduction in comparison to the central region, the intermediate region preferably has a smaller additional positive dioptric power or a smaller contrast reduction than the inner and outer effective regions or substantially no additional positive dioptric power or no contrast reduction.

Preferably, the additional positive dioptric power in the intermediate region, in comparison to the central region, is not greater than about 1 dpt, even more preferably not greater than about 0.5 dpt, most preferably not greater than about 0.25 dpt.

The central region preferably comprises a circular area with a radius of at least 3 mm, preferably at least 5 mm, even more preferably at least 10 mm. In other words, this means that the central region has a size and shape such that a circular area of this type with the specified radii is completely contained therein. Otherwise, the central region does not have to be exactly circular. It is also possible to provide an elliptical or generally oval shape as the central region. In one aspect, however, it is preferable if the central region lies within a circular area with a radius of at most 30 mm, preferably at most 20 mm, even more preferably at most 10 mm. This dimensioning of the central region (substantially) without an additional dioptric power achieves that a spectacle lens provided with the adhesion film still allows for a good central view with undistorted sharpness. At the same time, the additional positive dioptric power provided in the peripheral region moves far enough into the center of the field of vision to have an effective influence on the accommodation behavior of the eye.

When using an intermediate region (substantially) without an additional dioptric power between inner and outer effective regions, it is particularly preferable if the intermediate region is arranged within an annular region around a center of the adhesion film, which lies between an inner boundary circle with a radius of about 20 mm and an outer boundary circle with a radius of about 40 mm. In particular, a center point (e.g. geometric center of gravity or center point of an inscribed circle) of the central region (free of the additional power or contrast reduction) can, in this respect, serve as the center. Particularly preferably, the (annular) intermediate region has a (ring) width of no more than about 10 mm in the radial direction.

The intermediate region thus ensures that a central peripheral visual region is imaged on the retina with similar sharpness as the central visual region. It turned out that this is particularly efficient especially for the reliable perception of movements. However, the combination of the inner and outer effective regions still ensures that a full-surface sharp image behind the retina is avoided, thus attenuating the stimulus for length growth of the eye. This, in turn, improves the long-term wearing comfort of the spectacles. The combination of the effects of reliable perception of movements and the long-term wearing comfort is even significantly greater when using the described intermediate region without an additional dioptric power (or with a reduced additional dioptric power) or without a contrast reduction than when using an enlarged central region in combination with only a continuous peripheral region.

Preferably, the microstructure comprises a Fresnel structure, in particular a refractive one. In principle, diffractive structures would also be possible. However, refractive Fresnel structures are comparatively easy to produce with high quality. The Fresnel structures are particularly preferably provided on the functional surface of the adhesion film with a profile height (step height) in the range of about 0.01 mm to particularly about 0.2 mm, preferably in a range of about 0.02 mm to particularly about 0.2 mm. A step interval of the Fresnel structure is preferably in the range of about 0.2 mm to about 2 mm, even more preferably in a range of about 0.5 mm to about 1 mm.

In one aspect, the microstructure in the peripheral region at least partially causes the contrast reduction. To this end, the microstructure preferably comprises surface roughnesses which cause a dullness of the optical image. This dullness then leads to contrast reduction. In this respect, the central region should remain substantially clear, while the contrast reduction is only produced in the peripheral region. This contrast reduction contributes to the peripheral region providing no or less stimulus for length growth of the eye. This contrast reduction is particularly effective if the perception (or degree of perception) in the region of the contrast reduction caused thereby is in the range of at least about 0.5, preferably in the range of at least about 0.7. Preferably, the perception caused by the contrast reduction is not greater than about 0.9, even more preferably not greater than about 0.8.

Perception is to be understood here in particular as the factor by which the visual acuity (i.e. sharpness of vision) is reduced, wherein, in this context, in particular a visual acuity determined to the value of 1 in accordance with DIN 58220 Part 3 is assumed as a reference. Thus, a perception of 0 (<0.1) means substantially complete occlusion and 1 in principle means complete transparency. These properties result in particular with an arrangement of the adhesion film or a spectacle lens with the adhesion film in a position with a typical corneal vertex distance (CVD), i.e. in particular with at least one value of the CVD in the range of about 11 mm to about 18 mm, particularly preferably with at least one value of the CVD of about 13 mm or about 14 mm.

Alternatively or in addition to complying with the value ranges for perception proposed herein, it may be particularly preferable if the contrast reduction caused by the microstructure in the peripheral region results in a haze value (in particular % haze) in accordance with the ASTM D-1003 standard in the range of no more than about 10, preferably in the range of no more than about 2, and wherein preferably the contrast reduction caused by the microstructure in the peripheral region (22) results in a haze value in accordance with the ASTM D-1003 standard in the range of at least about 0.1, in particular at least about 0.5.

Particularly preferably, in the case of a contrast reduction, the peripheral region nevertheless has a transmittance (in particular a luminous tramsmittance value in accordance with the ASTM D-1003 standard) of at least 85, even more preferably at least 90. This ensures that, even in the case of a contrast reduction, the film does not completely block (e.g. absorb and/or reflect) the light and thus darkens the field of vision but that the light is only (partially) scattered. This largely preserves the impression of brightness and prevents the pupil from becoming noticeably larger (due to reduced light incidence).

The values for both haze and luminous transmittance in accordance with the ASTM D-1003 standard can be ascertained or checked using the “haze-gard plus” measuring device from BYK Additives and Instruments, for example.

In the case of a purely dioptric or contrast-reducing power of the microstructure, it is preferably only provided outside the central region, i.e. in particular in the peripheral region. Alternatively, however, a microstructure can also be provided in both the central and peripheral regions, wherein the additional positive dioptric power (and the contrast reduction, if applicable) is only achieved in the peripheral region. However, the microstructure can have a (uniform) additional prismatic power on the entire functional surface (i.e. including the central and peripheral regions).

Thereby, strabismus can be additionally compensated for, for example. Particularly preferably, however, a film of this type is also usable for near vision (e.g. for reading) by using the prismatic power horizontally with the prism base directed outwards. In this way, the stronger convergence requirement for the eyes due to the close-up triad creates an additional accommodation stimulus. The (tendency to) image in front of the retina thus achieved further supports the slowing down of advancement of myopia.

Thus, in a further aspect, the invention relates to a method for applying one adhesion film according to the invention to the spectacle lenses of spectacles, respectively, wherein the adhesion films preferably comprise a microstructure with a prismatic power on the entire functional surface and wherein the adhesion films are applied to right and left spectacle lenses of the spectacles such that the prism base of the prismatic power of the microstructure is on the outside (i.e. on the side of the respective spectacle lens facing away from the nose). This achieves that the convergence of the two eyes required for near vision is increased, especially when reading, in order to successfully fuse the images of the two eyes. Due to the near-vision triad, the increased convergence causes an additional accommodation stimulus. This also further contributes to achieving image formation in front of the retina.

Preferably, the value of the prismatic power is in the range of about 0.5 cm/m to about 15 cm/m, particularly preferably in the range of about 1 cm/m to about 10 cm/m. In this respect, this prismatic power is preferably the same in amount and direction over the entire adhesion film. In particular, the variation of the pure prismatic power over the functional surface (i.e. minus the peripheral, prismatic side power resulting from the dioptric power) is preferably not greater than about 2 cm/m, even more preferably not greater than about 1 cm/m.

Preferably, the adhesion film is provided such that it is cuttable for adaptation to the shape and size of spectacle lenses. For reliable positionability on a spectacle lens, the adhesion film preferably has a centering mark for centering the adhesion film relative to a centering point or a central viewing point of the spectacle lens.

Conversely, the simple application of the adhesion films to a spectacle lens also allows very simple replacement without the spectacle lens being altered or damaged. In addition, the adhesion films can be used quite universally, relatively independently of individual prescriptions for spectacle lenses. Thus, the adhesion films can be produced in series at very low cost and can also be used together with very high-quality, individually optimized and produced spectacle lenses. In this respect, on the one hand, the adhesion film ensures the well-fitted, high quality of central vision, while on the other hand it slows down the progression of myopia by reducing the stimulus for excessive accommodation, thus improving a lasting tolerability of spectacles and achieving long-term wearing comfort at low cost.

### BRIEF DESCRIPTION OF THE DRAWINGS

In the following, the invention is further described based on preferred embodiments with reference to the attached drawings. Shown are:

FIG. 1 a schematic cross-section through an exemplary adhesion film before it is applied to a spectacle lens:

FIG. 2 a schematic plan view of an exemplary adhesion film; and

FIG. 3 a schematic plan view of another exemplary adhesion film.

### DETAILED DESCRIPTION

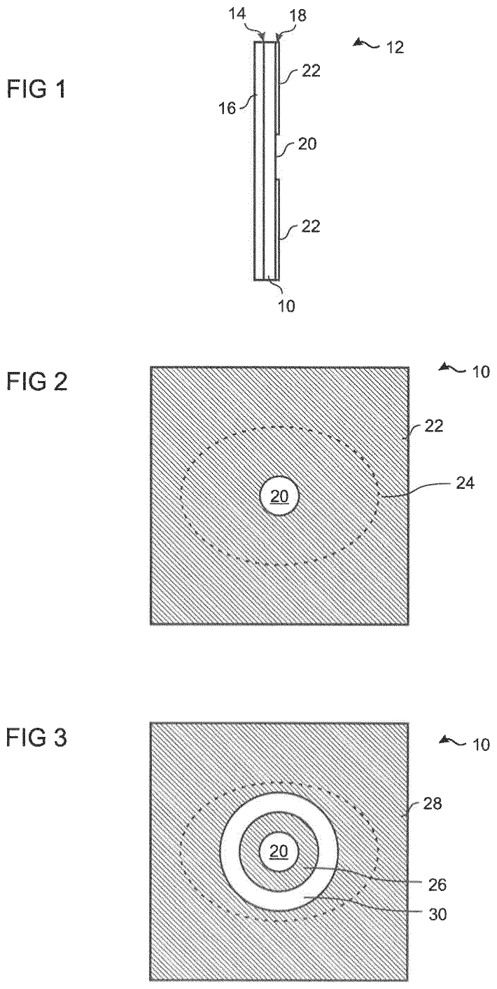

As shown schematically in FIG. 1, an adhesion film 10 for a spectacle lens according to a preferred embodiment is provided in the form of a blank 12 that has not yet been cut. Here, the adhesion film 10 comprises an adhesion surface 14 which is initially preferably protected from contamination by a peelable protective layer or protective film 16. After removing the protective film 16, the adhesion film can be applied to a front or rear surface of a spectacle lens in order to adhesively stick there. Therefore, no additional adhesion means, such as a glue, are required. Thus, the adhesion film can also be removed quite easily and gently for the spectacle lens without leaving any residue.

On the side opposite the adhesion surface 14, there is a functional surface 18 with a central region 20 and a peripheral region 22. Here, the functional surface 18 has a microstructure such that the microstructure in the peripheral region 22 at least partially produces an additional positive dioptric power in relation to the central region 18. Here, “positive dioptric” corresponds to the power of a converging lens in the usual manner.

FIG. 2 shows a plan view of an exemplary adhesion film 10. In this example, the adhesion film is initially provided as a rectangular (in particular square) blank, for example. This blank can then be cut along a cutting line 24, for example before being applied to a spectacle lens (and in particular before removing the protective film), in order to adapt the adhesion film individually to the shape of the spectacle lens. It is also possible to cut the adhesion film along the edge of the spectacle lens only after removing the protective film and, in particular, after applying the adhesion film to the spectacle lens.

However, it is desirable in any case that the central region 20 of the adhesion film, which is in particular largely free of a dioptric power, is positioned on a central viewing region or a main viewing region of the spectacle lens. This achieves that the overall dioptric power of the system on the spectacle lens and the adhesion film is substantially not changed by applying the adhesion films in this region. Thus, the spectacle wearer can still see sharply in this central main viewing region—even without additional accommodation by the eye. The peripheral visual region, on the other hand, is imaged slightly in front of the retina of the corresponding eye of the spectacle wearer due to the positive dioptric power of the adhesion film in the peripheral region with sharp vision in the central region. This suppresses excessive accommodation of the eye, which leads to a reduction in the progression of a myopic property of the eye and thus to better wearing comfort for the spectacle lens in the long term.

FIG. 3 shows a schematic plan view of another exemplary adhesion film 10. Unlike the example of FIG. 2, the peripheral region here does not continuously exhibit a positive dioptric power. Instead, the peripheral region comprises an inner effective region 26 and an outer effective region 28, which are radially separated from each other by an annular intermediate region 30. Preferably, the positive dioptric power in the intermediate region 30 is lower than in the inner effective region 26 and than in the outer effective region 28. On a line from the central region towards the periphery, the positive dioptric power in the intermediate region 30 thus preferably passes through a local minimum. Particularly preferably, the intermediate region 30, at least partially or for the most part, substantially does not have any dioptric power. Here, the ring width of the (substantially power-free) intermediate region 30 is preferably in the range of about 5 mm to about 10 mm.

In the schematic, exemplary embodiments, the central region and possibly the intermediate region and/or the inner effective region are illustrated in a circular shape. However, this is not necessarily the case. These regions may also have other shapes (e.g. oval). Also, these regions do not necessarily have to be concentric to each other, even though this may be particularly advantageous for some universal applications.

In addition to the additional positive dioptric power in the peripheral region, the adhesion film may also have a preferably substantially homogeneous prismatic power. This is particularly advantageous for use for near vision, for example for application on reading glasses. If adhesion films of this type with a continuous prismatic power are arranged on the spectacle lenses of spectacles such that the prismatic power is substantially horizontal and the prism base is on the outside, this creates an additional need for convergence of the eyes in near vision. This causes near-vision triad-induced accommodation which tends to result in image formation in front of the retina. This, in turn, attenuates further free accommodation stimulus of the eyes and thereby also slows down the progression of myopia of the eyes. This, in turn, can also increase or maintain the wearing comfort for spectacles in the long term.

The adhesion film according to the invention is particularly suitable for application with negative dioptric spectacle lenses (i.e. for compensating myopia) or for spectacles for near vision (e.g. reading spectacles). Especially for spectacles or areas of application of this type, the effect of long-term maintenance of the wearing comfort is particularly pronounced.

The microstructure in the functional surface, which in particular produces the additional positive dioptric power in the peripheral region, is preferably designed as a refractive Fresnel structure. In principle, however, it is also possible and effective to design this microstructure as a diffractive structure (e.g. diffractive Fresnel structure) or as an arrangement of microlenses.

1-17. (canceled)

18. An adhesion film for a spectacle lens, comprising:
an adhesion surface with which the adhesion film is arrangeable on a front or rear surface of the spectacle lens in order to adhesively stick there; and
a functional surface opposite the adhesion surface with a central region and a peripheral region, wherein the functional surface has a microstructure such that the microstructure in the peripheral region at least partially causes an additional positive dioptric power and/or a contrast reduction as compared to the central region.

19. The adhesion film according to claim 18, wherein the additional positive dioptric power is in a range of about 1 dpt to about 5 dpt.

20. The adhesion film according to claim 18, wherein the microstructure comprises a Fresnel structure.

21. The adhesion film according to claim 20, wherein a profile height of the Fresnel structure is in a range of at least about 0.01 mm; and/or wherein the profile height of the Fresnel structure is in a range of at most about 0.2 mm; and/or wherein a step interval of the Fresnel structure is in a range of at least about 0.2 mm; and/or wherein the step interval of the Fresnel structure is in a range of at most about 2 mm.

22. The adhesion film according to claim 18, wherein the contrast reduction caused by the microstructure in the peripheral region results in a perception in a range of at least about 0.5.

23. The adhesion film according to claim 18, wherein the contrast reduction caused by the microstructure in the peripheral region results in a haze value in accordance with an ASTM D-1003 standard in a range of no more than about 10.

24. The adhesion film according to claim 18, wherein an entire functional surface has a microstructure that has a prismatic power.

25. The adhesion film according to claim 24, wherein a value of the prismatic power is in a range of about 0.5 cm/m to about 15 cm/m.

26. The adhesion film according to claim 18, wherein the central region comprises a circular area with a radius of at least 3 mm.

27. The adhesion film according to claim 18, wherein the central region lies within a circular area with a radius of at most 30 mm.

28. The adhesion film according to claim 18, further comprising:
an inner effective region and an outer effective region in the peripheral region, which are separated from each other by an intermediate region,
wherein the intermediate region has a lower additional positive dioptric power than the inner and the outer effective region.

29. The adhesion film according to claim 28, wherein the intermediate region is arranged within an annular region with an inner radius of about 20 mm and an outer radius of about 40 mm around a center which lies within the central region.

30. The adhesion film according to claim 18, which is cuttable for adaptation to a shape and size of spectacle lenses.

31. The adhesion film according to claim 18, further comprising:
a centering mark operable to center the adhesion film relative to a centering point or a central viewing point of a spectacle lens.

32. A method for applying an adhesion film according to claim 18 to the spectacle lens, wherein the adhesion film comprises a microstructure with a prismatic power on an entire functional surface, and the adhesion film is applied to right and left spectacle lenses of spectacles such that a prism base of the prismatic power of the microstructure is on outsides of the right and left spectacle lens.

33. A spectacle lens with a negative dioptric power, comprising:
the adhesion film according to claim 18.

34. The adhesion film according to claim 18, wherein the adhesion film reduces a progression of myopia in a non-therapeutic manner.
